(19) United States
(12) Patent Application Publication
(10) Pub. No.: US 2016/0131817 A1
(43) Pub. Date: May 12, 2016

(54) METHOD FOR PRODUCING LAMINATE, LAMINATE, LIGHT GUIDE BODY FOR LIGHT SOURCE DEVICES, AND LIGHT SOURCE DEVICES

(71) Applicant: MITSUBISHI RAYON CO., LTD., Tokyo (JP)

(72) Inventors: Yasuo WAKUI, Yokohama-shi (JP); Tomonari YOSHIMURA, Yokohama-shi (JP); Kenji YAGI, Yokohama-shi (JP); Kouichi TAKENAKA, Tokyo (JP)

(73) Assignee: Mitsubishi Rayon Co., Ltd., Chiyoda-ku (JP)

(21) Appl. No.: 14/898,513

(22) PCT Filed: Aug. 5, 2014
(86) PCT No.: PCT/JP2014/070577

§ 371 Date: Dec. 15, 2015

(30) Foreign Application Priority Data
Aug. 7, 2013 (JP) 2013-163826

(51) Int. Cl. F21V 8/00; G02B 1/04

(52) U.S. Cl. CPC G02B 6/0038; G02B 6/0055; G02B 6/0065; G02B 1/046

(57) ABSTRACT

A laminate which is provided with a core layer, a first cladding layer, a second cladding layer and a light output means, and wherein the second cladding layer, the core layer and the first cladding layer are sequentially laminated. The refractive index of the first cladding layer and the refractive index of the second cladding layer is lower than the refractive index of the core layer. The light output means is composed of a recess that penetrates through the first cladding layer and reaches the inside of the core layer, and the curvature radius of the forefront part of the recess is 10 μm or less.

### TECHNICAL FIELD

The present invention relates to a method for producing a laminate, a laminate, a light guide body for light source device, and a light source device.

The present application contains subject matter related to Japanese Patent Application No. 2013-163826 filed in the Japanese Patent Office on Aug. 7, 2013, the entire contents of which are incorporated herein by reference.

### BACKGROUND ART

In the related art, as a light source device used for a liquid crystal display device used for a mobile phone, a notebook PC, an LCD TV, a video camera, or the like, a display device such as backlight keys of a mobile phone, a backlight keyboard of a PC, or display switch of an electronic apparatus or a car, or an illumination device of indoor lighting such as a ceiling light, an illumination signal, or the like, for example, there are a direct-under type light source device where a line-shaped light source such as a fluorescent lamp is arranged or a plurality of point light sources such as light emitting diodes are arranged in a housing, an edge-light type light source device where a line-shape light source is arranged or point light sources are arranged on a side surface of a plate-shaped light guide body, and the like.

Typically, the edge-light type light source device includes a transparent light guide body of an acrylic resin plate having a rectangular plate shape and a light source. The light source is arranged to face the side surface of the light guide body. In the light source device, light from the light source is incident from a side surface (light incidence surface) on the light guide body, and light is emitted from an emitting mechanism formed on a first surface (sometimes, referred to as a light emitting surface) or a second surface (sometimes, referred to as a rear surface) which is a surface facing the first surface of the light guide body or is emitted from a light emitting surface by a light emitting element of light diffusion particles or the like contained in the light guide body.

In such a light guide body, since the light incident from the side surface is emitted from the rear surface of the light guide body as well as from the light emitting surface, the amount of light emitted from the light emitting surface is decreased. Therefore, in the light source device, a light reflecting layer is installed on the second surface of the light guide body, that is, the surface facing the light emitting surface of the light guide body to reflect the light emitted from the second surface, and thus, the light is emitted from the light emitting surface or returned into the light guide body, so that the light emitted from the second surface is reused. In this manner, by using the light from the light source with high efficiency, it is possible to obtain a light source device having excellent luminance.

Patent Document 1 discloses a light guide body for light source device having excellent luminance by installing an light emitting element on a front surface of the light guide body having a core clad structure by laser processing and incorporating a function of a light reflecting layer into the light guide body.

### CITATION LIST

### Patent Document

Patent Document 1: WO 2010/073726 A

### SUMMARY OF THE INVENTION

### Problem to be Solved by the Invention

However, in the light guide body for light source device disclosed in Patent Document 1, since laser process is used as a method of installing the light emitting element, there are problems in that it takes a certain time to install individual light emitting elements, and the shape of the light emitting element is difficult to be controlled, and yellowing occurs in the obtained light guide body for light source device due to the laser.

An object of the invention is to provide a laminate having little yellowing.

In addition, another object of the invention is to provide a method for producing a laminate capable of simply installing a light emitting element by preventing yellowing of the laminate.

In addition, still another object of the invention is to provide a light source device having little yellowing.

### Means for Solving Problem

The above objects are achieved by the invention disclosed in (1) to (15) as follows.

(1) A laminate including a core layer, a first cladding layer, a second cladding layer, and a light emitting element, wherein the second cladding layer, the core layer, and the first cladding layer are sequentially laminated, wherein a refractive index of the first cladding layer and a refractive index of the second cladding layer are lower than a refractive index of the core layer, wherein the light emitting element is a concave portion penetrating the first cladding layer and reaching an inner portion of the core layer, and wherein a radius of curvature of a distal end portion of the concave portion is 10 μm or less.

(2) The laminate according to (1), wherein the radius of curvature of the distal end portion of the concave portion is 3 μm or less.

(3) The laminate according to (1) or (2), wherein the light emitting element is installed by press processing.

(4) The laminate according to any one of (1) to (3), wherein a depth of the light emitting element is larger by 5 μm or more than a thickness of the first cladding layer.

(5) A laminate including a core layer, a first cladding layer, a second cladding layer, and a light emitting element, wherein the second cladding layer, the core layer, and the first cladding layer are sequentially laminated, wherein a material constituting the core layer is a polycarbonate resin, wherein a refractive index of the first cladding layer and a refractive index of the second cladding layer are lower than a refractive index of the core layer, wherein the light emitting element is a concave portion penetrating the first cladding layer and reaching an inner portion of the core layer, and wherein a yellowness index of the laminate measured in accordance with ASTM Standard D1925 is −3 or less.

(6) The laminate according to (5), wherein a radius of curvature of a distal end portion of the concave portion is 10 μm or less.

(7) The laminate according to any one of (1) to (6), further including a light reflecting layer.

(8) The laminate according to any one of (1) to (7), further including a layer of at least one type selected from a group including a design layer and a light diffusion layer.

(9) A method for producing a laminate including laminating a first cladding layer on a first surface of a core layer, laminating a second cladding layer on a second surface of the core layer, and installing a light emitting element, wherein a refractive index of the first cladding layer and a refractive index of the second cladding layer are lower than a refractive index of the core layer, and wherein the light emitting element is installed by press processing.

(10) The method for producing a laminate according to (9), wherein the light emitting element is a concave portion penetrating the first cladding layer and reaching an inner portion of the core layer.

(11) The method for producing a laminate according to (9) or (10), wherein a radius of curvature of a distal end portion of the concave portion is 10 um or less.

(12) The method for producing a laminate according to any one of (9) to (11), wherein a machining blade used for the press processing is of a corrosion type.

(13) A laminate obtained by the method for producing a laminate according to any one of (9) to (11).

(14) A light guide body for light source device including the laminate according to any one of (1) to (8).

(15) A light source device including the laminate according to any one of (1) to (8).

### Effect of the Invention

A laminate according to the invention has little yellowing.

A method for producing a laminate according to the invention can simply install a light emitting element of which shape is controlled by preventing yellowing of the laminate.

A light source device according to the invention has little yellowing.

### BRIEF DESCRIPTION OF DRAWINGS

FIG. 1 is a schematic cross-sectional diagram illustrating an embodiment of a laminate according to the invention;

FIG. 2 is a schematic cross-sectional diagram illustrating an embodiment of a laminate according to the invention;

FIG. 3 is a schematic cross-sectional diagram illustrating an embodiment of a light source device using the laminate according to the invention; and

FIG. 4 is a diagram illustrating a luminance distribution of a light source device obtained in Example 1.

### MODE(S) FOR CARRYING OUT THE INVENTION

Hereinafter, embodiments of the invention will be described with reference to the drawings, but the invention is not limited to the embodiments and the drawings.

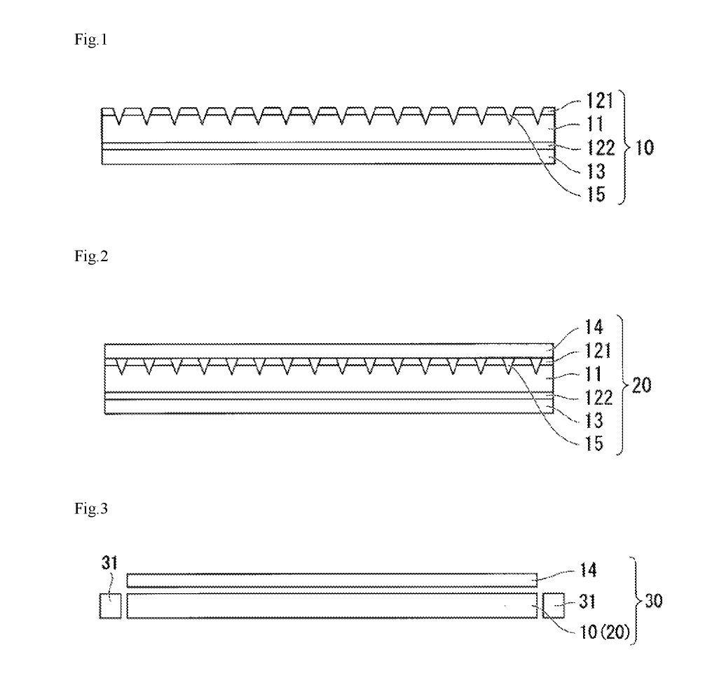

FIG. 1 is a schematic cross-sectional diagram illustrating an embodiment of a laminate 10 (hereinafter, simply referred to as a laminate 10 according to the invention) as one aspect of the invention.

(Laminate 10)

The laminate according to the invention is a laminate including a core layer 11, a first cladding layer, and a second cladding layer. In addition, the laminate is a laminate where the second cladding layer, the core layer, and the first cladding layer are sequentially laminated and a refractive index of the first cladding layer and a refractive index of the second cladding layer are lower than a refractive index of the core layer 11.

Hereinafter, in the core layer 11, an interface between the core layer 11 and the first cladding layer 121 is referred to as a first surface of the core layer 11, and an interface between the core layer 11 and the second cladding layer 122 is referred to as a second surface of the core layer 11. In addition, in the first cladding layer 121, a surface facing the interface between the first cladding layer 121 and the core layer 11 is referred to as a first surface of the first cladding layer 121, and the interface between the first cladding layer 121 and the core layer 11 is referred to as a second surface of the first cladding layer 121. In the second cladding layer, the interface between the second cladding layer 122 and the core layer 11 is referred to as a first surface of the second cladding layer 122, and a surface facing the interface between the second cladding layer 122 and the core layer 11 is referred to as a second surface of the second cladding layer 122.

The laminate 10 illustrated in FIG. 1 includes the core layer 11, the first cladding layer 121, and the second cladding layer 122. The laminate further includes a light reflecting layer 13 on the second surface of the second cladding layer 122 and a light emitting element 15 which extends from the first surface of the first cladding layer 121 to an inner portion of the core layer 11.

The shape of the laminate 10 is a plate shape, which is not particularly limited. The configuration that the shape of the laminate 10 is a plate shape denotes that a thickness T of the laminate 10 is small and an area of the first surface of the first cladding layer 121 is large. More specifically, the thickness T of the laminate 10 is preferably in a range of 0.03 to 12 mm, more preferably, in a range of 0.2 to 5.5 mm, and the area of the first surface of the first cladding layer 121 is preferably in a range of 200 to 500000 mm², more preferably in a range of 500 to 250000 mm². The thickness T of the laminate 10 is a distance between the second surface of the second cladding layer 122 and the first surface of the first cladding layer 121. The thickness T of the laminate 10 is calculated by mounting the laminate 10 on a horizontal plane, cutting the laminate in a vertical direction to obtain a cross section, photographing the cross section with a microscope, measuring the shortest distance from an arbitrary point of the second surface of the second cladding layer 122 to the first surface of the first cladding layer 121 at arbitrary five positions (however, in the portion where the light emitting element 15 is not installed), and obtaining an average value thereof. In addition, as a shape of the laminate 10, for example, a polygonal shape such as a rectangle or a triangle or a circular shape such as a true circle or an ellipse is exemplified in a case where the laminate 10 is mounted on the horizontal plane and seen from the vertical direction. Among these shapes, in a case where the laminate 10 is used as the light source device 30, workability is excellent, and light from the light source 31 is easily incident. Therefore, as the shape of the laminate 10, the polygonal shape is preferred, and the rectangular shape is more preferred.

The laminate 10 may also have a shape where the entire portion thereof is curved or bent.

(Core Layer 11)

The core layer 11 is configured with a highly transparent material, which is not particularly limited, and the material can be appropriately selected according to the purpose of use or the like. The phrase “highly transparent” denotes that a value of transmittance measured in accordance with ISO 13468 is in a range of 50 to 100%.

As the core layers 11, for example, an acrylic resin, a polycarbonate resin, an acrylic polyolefin resin, a glass and the like can be exemplified. Among these materials of the core layer 11, due to a light weight and an excellent handling property, the acrylic resin, the polycarbonate resin, and the acrylic polyolefin resin are preferred.

The acrylic resin is preferred due to excellent transparency, excellent durability, and inexpensiveness.

As the acrylic resin, for example, a methyl methacrylate homopolymer, a copolymer of methyl methacrylate and other monomers, and the like can be exemplified. Among these acrylic resins, due to more excellent transparency, excellent durability, and more inexpensiveness, the methyl methacrylate homopolymer and a copolymer containing methyl methacrylate units of 50 mass % or more and less than 100 mass % over a total mass of the copolymer are preferred.

In the case of using the copolymer of methyl methacrylate and other monomers, the content of the methyl methacrylate units in the copolymer is preferably 50 mass % or more and less than 100 mass % over the total mass of the copolymer, more preferably 60 mass % or more and less than 100 mass %, still more preferably 70 mass % or more and less than 100 mass %.

As other monomers, for example, (meth) acrylates such as methyl acrylate, ethyl (meth) acrylate, n-propyl (meth) acrylate, n-butyl (meth) acrylate, n-hexyl (meth) acrylate, and cyclohexyl (meth) acrylate; a (meth) acrylic acid; a maleic anhydride; maleimides; and aromatic vinyls such as styrene can be exemplified.

In addition, in this specification, the (meth) acrylate denotes an acrylate or a methacrylate.

The polycarbonate resin and the acrylic polyolefin resin are preferred due to excellent heat resistance and excellent incombustibility. In particular, since the refractive index of the polycarbonate resin is high and a numerical aperture thereof can be increased, although the laminate 10 is bent, light leakage can be suppressed to be small, so that the polycarbonate resin is preferred.

In addition, the numerical aperture is an indicator of collection of light. As the numerical aperture is increased, the amount of received light can be increased. Therefore, although the laminate 10 is bent, the light leakage can be suppressed to be small.

Due to easiness of formation of the laminate 10 and capability of thinning the light source device 30, the thickness of the core layer 11 is preferably in a range of 0.01 to 10 mm, more preferably in a range of 0.05 to 5 mm.

The thickness of the core layer 11 is a distance between the second surface and the first surface of the core layer 11. The thickness of the core layer 11 is calculated by mounting the laminate on a horizontal plane, cutting the core layer 11 in a vertical direction to obtain a cross section, photographing the cross section with a microscope, measuring the shortest distance from an arbitrary point of the second surface of the core layer 11 to the first surface of the core layer 11 at arbitrary five positions (however, in the portion where the light emitting element 15 is not installed), and obtaining an average value thereof.

(First Cladding Layer 121, Second Cladding Layer 122)

The first cladding layer 121 and the second cladding layer 122 are configured with a highly transparent material having a refractive index lower than the refractive index of the core layer 11, which is not particularly limited, and the material can be appropriately selected according to the purpose of use or the like.

As the material of the first cladding layer 121 and the second cladding layer 122, a material having a refractive index lower than the refractive index of the core layer 11 can be appropriately selected.

In the case of using the acrylic resin as the material of the core layer 11, as the material of the first cladding layer 121 and the second cladding layer 122, for example, a fluorine-containing olefin resin or the like can be exemplified.

As the fluorine-containing olefin resin, for example, a vinylidene fluoride homopolymer, a copolymer of vinylidene fluoride and tetrafluoroethylene, a copolymer of vinylidene fluoride and hexafluoropropylene, a copolymer of vinylidene fluoride and trifluoroethylene, a copolymer of vinylidene fluoride, tetrafluoroethylene, and hexafluoropropylene, and the like can be exemplified. Among these fluorine-containing olefin resins, due to excellent processability or moldability, the vinylidene fluoride homopolymer is preferred.

In the case of using the polycarbonate resin as the material of the core layer 11, as the material of the first cladding layer 121 and the second cladding layer 122, for example, a fluorine-containing olefin resin, an acrylic resin, and the like can be exemplified.

Specific examples of the fluorine-containing olefin resin and the acrylic resin are same as described above, and the preferable ranges and the reasons are also same as described above.

A difference in refractive index between the refractive index n₁ of the core layer 11 and the refractive index n₂ of the first cladding layer 121 and/or the second cladding layer 122 is preferably 0.001 or more, more preferably 0.01 or more. If the difference in refractive index between the refractive index n₁ of the core layer 11 and the refractive index n₂ of the first cladding layer 121 and/or the second cladding layer 122 is 0.001 or more, light incident from a light incidence surface can propagate to a faraway site with little loss while totally reflecting on the interface between the core layer 11 and the first cladding layer 121 and the interface between the core layer 11 and the second cladding layer 122, and even though other layers are installed on front surfaces of the first cladding layer 121 and/or the second cladding layer 122, light leakage becomes small.

In addition, the difference in refractive index between the refractive index n₁ of the core layer 11 and the refractive index n₂ of the first cladding layer 121 and/or the second cladding layer 122 is defined as a value obtained by subtracting the refractive index n₂ of the first cladding layer 121 and/or the second cladding layer 122 from the refractive index n₁ of the core layer 11.

The refractive index is defined as a value obtained by measurement using sodium D line at 23° C. with an Abbe refractometer in accordance with ISO 13468.

Due to excellent handling property and capability of obtaining the laminate 10 having excellent light confinement efficiency, the thickness of the first cladding layer 121 and the second cladding layer 122 is preferably in a range of 1 to 500 μm, more preferably in a range of 3 to 100 μm.

The thickness of the first cladding layer 121 is calculated by mounting the laminate on a horizontal plane, cutting the first cladding layer 121 in a vertical direction to obtain a cross section, photographing the cross section with a microscope, measuring the shortest distance from an arbitrary point of the second surface of the first cladding layer 121 to the first surface of the first cladding layer 121 at arbitrary five positions (however, in the portion where the light emitting element 15 is not installed), and obtaining an average value thereof. The thickness of the second cladding layer 122 is calculated by mounting the laminate on a horizontal plane, cutting the second cladding layer 122 in a vertical direction to obtain a cross section, photographing the cross section with a microscope, measuring the shortest distance from an arbitrary point of the second surface of the second cladding layer 122 to the first surface of the second cladding layer 122 at arbitrary five positions (however, in the portion where the light emitting element 15 is not installed), and obtaining an average value thereof.

A ratio between the thickness of the core layer 11 and the thickness of the first cladding layer 121 and a ratio between the thickness of the core layer 11 and the thickness of the second cladding layer 122 can be appropriately selected according to the material of the core layer 11 and the material of the first cladding layer 121 and the second cladding layer 122.

A ratio between the volume of the core layer 11 and the volume of the first cladding layer 121 and a ratio between the volume of the core layer 11 and the volume of the second cladding layer 122 can be appropriately selected according to the material of the core layer 11 and the material of the first cladding layer 121 and the second cladding layer 122.

The materials, thicknesses, and volumes of the first cladding layer 121 and the second cladding layer 122 may be equal to each other or may be different from each other.

The side surface of the core layer 11 may be covered with the first cladding layer 121 and/or the second cladding layer 122 or may not be covered.

As a method of laminating the second cladding layer 122, the core layer 11, and the first cladding layer 121, for example, a method of obtaining a laminate by integrally molding the second cladding layer 122, the core layer 11, and the first cladding layer 121 through multilayer melt extrusion, a method of obtaining a laminate by coating the first surface of the core layer 11 with the first cladding layer 121 and coating the second surface of the core layer 11 with the second cladding layer 122, and the like can be exemplified.

As the method of the coating process, for example, a die coating method, a gravure coating method, a spin coating method, a dip coating method, a bar coating method, a spray coating method, a printing method, and the like can be exemplified.

As the method of the printing process, for example, a screen printing method, an inkjet printing method, and the like can be exemplified.

(Light Reflecting Layer 13)

The light reflecting layer 13 is a layer capable of scattering and reflecting light, which is not particularly limited, and the material can be appropriately selected according to the purpose of use or the like.

As the light reflecting layer 13, for example, a resin layer obtained by coating a resin reflecting visible light with resin ink of a vinyl-based resin, a polyester-based resin, an acrylic resin, an urethane-based resin, an epoxy-based resin, or the like; a resin plate or a resin film of a polyolefin resin, a polyester resin, an acrylic resin, or the like; paper of cellulose or the like; a metal plate or a metal thin film of aluminum, nickel, gold, platinum, chromium, iron, copper, indium, tin, silver, titanium, lead, zinc, or the like, and the like can be exemplified. Among the light reflecting layers 13, due to the capability of easily adjusting the reflectance, the resin layer obtained by coating the resin reflecting visible light with the resin ink is preferred.

The light reflecting layer 13 may be formed by foaming or may include a pigment or diffusion particles.

As the pigment, for example, a white pigment of titanium oxide, barium sulfate, calcium carbonate, magnesium carbonate, or the like can be exemplified. One type of these pigments may be solely used, and two or more types may be used in combination or mixed. Among these pigments, due to highness of the reflectance over the entire range of visible light, the white pigment is preferred.

As the material of the diffusion particles, for example, a silicon resin, an acrylic resin, a styrene resin, and the like can be exemplified. One type of these diffusion materials may be solely used, and two or more types may be used in combination or mixed.

Since the reflectance of the light reflecting layer 13 greatly influences on the luminance of the light source device 30, preferably, the material, the thickness, the content of pigments or diffusion particles, or the like is appropriately selected according to optical characteristics of interest.

In a case where only one surface of the light source device 30 is allowed to emit light, due to excellent luminance of the light source device 30, the reflectance of the light reflecting layer 13 is preferably 70% or more, more preferably in a range of 70 to 100%, still more preferably in a range of 75 to 100%, even still more preferably in a range of 80 to 100%.

In a case where both surfaces of the light source device 30 is allowed to emit light, in order to easily balancing the luminance between the both surfaces of the light source device 30, the reflectance of the light reflecting layer 13 is preferably 65% or less, more preferably in a range of 25 to 65%, still more preferably in a range of 30 to 60%.

In addition, the reflectance of the light reflecting layer 13 is measured by a method in accordance with JIS K 7375.

The thickness of the light reflecting layer 13 may be appropriately selected according to the reflectance of the light reflecting layer 13 or the purpose of the laminate 10. Even when the laminate 10 is bent, the light reflecting layer 13 is little peeled; the durability of the laminate 10 is excellent; and the light reflecting layer can also function as a protective film of the laminate 10. Therefore, the thickness of the light reflecting layer 13 is preferably in a range of 0.01 to 500 μm, more preferably in a range of 0.1 to 200 μm.

The thickness of the light reflecting layer 13 is calculated by mounting the laminate on a horizontal plane, cutting the light reflecting layer 13 in a vertical direction to obtain a cross section, photographing the cross section with a microscope, measuring the shortest distance from an arbitrary point of the surface of the light reflecting layer 13 facing an interface between the light reflecting layer 13 and the layer being in contact with the light reflecting layer 13 to the interface between the light reflecting layer 13 and the layer being in contact with the light reflecting layer 13 at arbitrary five positions (however, in the portion where the light emitting element 15 is not installed), and obtaining an average value thereof.

The light reflecting layer 13 is installed on the second surface of the second cladding layer 122. In addition, the light reflecting layer 13 may be installed on the first surface of the first cladding layer.

In a case where only one surface of the light source device 30 is desired to emit light, due to excellent luminance of the light source device 30, the light reflecting layer 13 is preferably installed on only one surface of the laminate 10.

In a case where both surfaces of the light source device 30 are desired to emit light, the light reflecting layer 13 may be installed on only one surface of the laminate 10 or may be installed on both surfaces of the laminate 10.

The light reflecting layer 13 may cover the entire surfaces of the first cladding layer 121 and/or the second cladding layer 122 or may cover partial areas of the first cladding layer 121 and/or the second cladding layer 122.

As a method of installing the light reflecting layer 13 on the second surface of the second cladding layer 122, for example, a method of coating the second surface of the second cladding layer 122 with the light reflecting layer 13, a method of coating the second surface of the second cladding layer 122 with an adhesive layer and laminating the light reflecting layer 13, a method of laminating the light reflecting layer 13 having an adhesive layer on the second surface of the second cladding layer 122, and the like can be exemplified. Among these methods of installing the light reflecting layer 13 on the second surface of the second cladding layer 122, due to easiness in adjusting the reflectance, the method of coating the second surface of the second cladding layer 122 with the light reflecting layer 13 is preferred.

As the method of the coating process, the above-described methods can be exemplified. As the method of the coating process of the metal thin film, for example, a vacuum deposition method, a sputtering method, an ion plating method, a plating method, and the like can be exemplified.

The method of installing the light reflecting layer 13 on the first surface of the first cladding layer 121 is same as the method of installing the light reflecting layer 13 on the second surface of the second cladding layer 122.

The adhesive layer is configured with a highly transparent material having excellent adhesion with respect to a to-be-adhered layer, and the material can be appropriately selected according to the purpose of use or the like.

As the material of the adhesive layer, for example, an acrylic adhesive agent, a natural rubber-based adhesive agent, a synthetic rubber-based adhesive agent, a silicon-based adhesive agent, a urethane-based adhesive agent, an epoxy-based adhesive agent, and the like can be exemplified. One type of these adhesive agents may be solely used, and two or more types may be used in combination or mixed. Among these adhesive agents, due to excellent adhesion, the acrylic adhesive agent, the natural rubber-based adhesive agent, the synthetic rubber-based adhesive agent, the silicon-based adhesive agent, the urethane-based adhesive agent, the epoxy-based adhesive agent are preferred, and the acrylic adhesive agent, the natural rubber-based adhesive agent, and the synthetic rubber-based adhesive agent are more preferred, and the acrylic adhesive agent are still more preferred.

Even when the laminate 10 is bent, the deformation is small, and the handling property of the laminate 10 is excellent. Therefore, the thickness of the adhesive layer is preferably in a range of 1 to 500 μm, more preferably in a range of 3 to 100 μm.

The thickness of the adhesive layer is calculated by mounting the laminate 10 on a horizontal plane, cutting the adhesive layer in a vertical direction to obtain a cross section, photographing the cross section with a microscope, measuring the shortest distance from an arbitrary point of the surface of the adhesive layer facing an interface between the layer adhered to the adhesive layer and the adhesive layer to the interface between the layer adhered to the adhesive layer and the adhesive layer at arbitrary five positions (however, in the portion where the light emitting element 15 is not installed), and obtaining an average value thereof.

(Design Layer or Light Diffusion Layer 14)

The laminate according to the invention may include a design layer or light diffusion layer 14 which is installed on the first surface of the first cladding layer 121.

The laminate 20 illustrated in FIG. 2 further includes the design layer or light diffusion layer 14 which is installed on the first surface of the first cladding layer 121 of the laminate 10.

The design layer is a layer having a purpose of allowing a design such as a picture or a character to emit light, and for example, a layer where design printing is directly performed on a light emitting surface of the laminate 10 by using a well-known method, a film where design printing is performed on a film having a light transmitting property by using a well-known method, and the like can be exemplified.

As the method of the printing process, the above-described methods can be exemplified.

The light diffusion layer is a layer having a purpose of diffusing light so as for the light emitting element 15 during the light emission not to be directly visually-recognized, and for example, a well-known light diffusion film and the like can be exemplified.

As a method of installing the design layer or light diffusion layer 14, for example, a method of installing the design layer or light diffusion layer by coating the light emitting surface with the design layer or light diffusion layer 14, a method of coating the light emitting surface with an adhesive layer and laminating the design layer or light diffusion layer 14, a method of laminating the design layer or light diffusion layer 14 having an adhesive layer on the light emitting surface, and the like can be exemplified. Among these methods of installing the design layer or light diffusion layer 14, due to excellent productivity, the method of laminating the design layer or light diffusion layer 14 having an adhesive layer on the light emitting surface is preferred.

As the method of the coating process, the above-described methods can be exemplified. As the adhesive layer, the above-described adhesive layers can be used.

In addition, as one aspect of the invention, the light emitting surface denotes the first surface of the first cladding layer 121 of the laminate 10.

The laminate according to the invention may include a protective film installed on the front surface thereof in order to prevent scratches during the process or during the transportation. In addition, the light reflecting layer 13 or the design layer or light diffusion layer 14 can also function as a protective film.

A general light guide body needs to include a protective film installed on the front surface thereof in order to prevent scratches during the process or during the transportation. Since the light reflecting layer 13 or the design layer or light diffusion layer 14 are installed to have a function of a protective film such as scratch prevention, the laminate including the light reflecting layer 13 or the design layer or light diffusion layer 14 needs not include a separate protective film installed on the front surface and is preferred.

In order to improve adhesion between the layers, before performing the coating or the laminating, a process such as corona discharging or plasma discharging may be applied on the surfaces of the layers to reform the surfaces.

(Light Emitting Element 15)

The laminate according to the invention includes the light emitting elements 15.

Each of the laminate 10 illustrated in FIG. 1 and the laminate 20 illustrated in FIG. 2 includes the light emitting elements 15.

The light emitting element 15 is an element of allowing the light propagating through the inner portion of the core layer 11 to emit to the outside of the core layer 11, and for example, a concave portion penetrating the first cladding layer 121 and reaching an inner portion of the core layer 11, a concave portion penetrating the second cladding layer 122 and reaching an inner portion of the core layer 11, a concave portion formed not to penetrate the first cladding layer 121 and to reach from the interface between the first cladding layer 121 and the core layer 11 to an inner portion of the core layer 11, a concave portion formed not to penetrate the second cladding layer 122 and to reach from the interface between the second cladding layer 122 and the core layer 11 to an inner portion of the core layer 11, and the like can be exemplified. One type of these light emitting elements 15 may be solely used, and two or more types may be used in combination. Among these light emitting elements 15, due to easiness in controlling the light emitting position, the concave portion penetrating the first cladding layer 121 and reaching an inner portion of the core layer 11 and the concave portion penetrating the second cladding layer 122 and reaching an inner portion of the core layer 11 are preferred, and the concave portion penetrating the first cladding layer 121 and reaching an inner portion of the core layer 11 is more preferred.

By reflection or refraction at the concave portion penetrating the first cladding layer 121 and reaching an inner portion of the core layer 11, the light propagating through the inner portion of the core layer 11 is emitted from the light emitting element 15 of the light emitting surface. Otherwise, the light is reflected by the light emitting element 15 to reach the light reflecting layer 13, and after scattering and reflection, the light is emitted from the light emitting surface. Otherwise, the light is reflected by the light emitting element 15 to pass through the light reflecting layer 13 to be emitted or to be returned to the core layer 11 to be guided to propagate.

In addition, as one aspect of the invention, the light emitting surface denotes the first surface of the first cladding layer 121 of the laminate 10.

The shape, size, depth, interval, and the like of the light emitting element 15 may be appropriately selected according to an amount of light, an optical guiding distance, an emission type required in the laminate 10 or 20, or the like, and for example, these may be set to be the same manner as WO 2010/073726 A.

As the shape of the light emitting element 15, a conical shape, a pyramid shape, a line shape, and the like where the distal end portion is a concave portion having a radius of curvature of 10 μm or less can be exemplified.

The line-shaped concave portion denotes, for example, a concave portion where a straight line or a curve in the deepest portion of the light emitting element 15 is formed so that the space of the concave portion spreads from the deepest portion of the light emitting element 15 toward the first cladding layer 121. Namely, in case of the straight line shape, a triangular prism shape having a distal end portion having a very shape acute angle is formed.

In a case where the light emitting element 15 has a conical shape or a pyramid shape, the distal end portion denotes a vertex of a cone or a pyramid. In a case where the light emitting element has a line shape, the distal end portion denotes one corner (edge) of a triangular prism, that is, a line of intersection of side surfaces constituting the triangular prism. The side surfaces constituting a triangular prism denote rectangular surfaces of the triangular prism. One type of these light emitting elements 15 may be solely used, and two or more types may be used in combination.

The light emitting element 15 is disposed so that the deepest portion of the light emitting element is the distal end portion of the light emitting element 15. For example, in a case where the light emitting element 15 is a concave portion penetrating the first cladding layer 121 and reaching an inner portion of the core layer 11, the light emitting element 15 exists to be inclined so as to spread from the deepest portion of the light emitting element 15 toward the first cladding layer 121.

The size of the light emitting element 15 is appropriately selected according to the materials of the core layer 11, the first cladding layer 121, the second cladding layer 122, and the light reflecting layer 13.

The depth D of the light emitting element 15 is preferably a depth of the light emitting element which penetrates the first cladding layer 121, reaches an inner portion of the core layer 11, and does not penetrate the core layer 11. Namely, the depth D of the light emitting element 15 preferably satisfies d1<D<d1+d11 with respect to the thickness dl of the first cladding layer 121, and the thickness d11 of the core layer 11. If the size of the light emitting element 15 is in the aforementioned range, a sufficient amount of the light propagating through the inner portion of the core layer 11 can be extracted from the core layer 11. In addition, the depth D of the light emitting element 15 is preferably larger by 5 μm or more than the thickness d1 of the first cladding layer 121. Namely, more preferably, d1+5 μm D≦d1+d11 is satisfied. In addition, the depth D of the light emitting element 15 is preferably larger by 5 to 500 μm or more, more preferably larger by 10 to 200 μm or more than the thickness d1 of the first cladding layer 121.

The depth D of the light emitting element 15 is preferably in a range of 0.1 to 1000 μm, more preferably in a range of 0.5 to 500 μm.

In addition, as one aspect of the invention, the depth D of the light emitting element 15 is defined as a distance from the first surface of the first cladding layer 121 to the deepest portion of the light emitting element 15.

The width W of the light emitting element 15 may be appropriately selected according to the materials of the core layer 11, the first cladding layer 121, the second cladding layer 122, and the light reflecting layer 13.

The width W of the light emitting element 15 is preferably in a range of 1 to 10000 μm, more preferably in a range of 5 to 5000 μm.

In addition, the width W of the light emitting element 15 is defined as a maximum width of the light emitting element 15 in the horizontal direction thereof when the laminate is mounted on a horizontal plane.

The depth D and the width W of the light emitting element 15 can be calculated by photographing the laminate 10 or 20 where the light emitting element 15 is installed with a microscope, measuring the depth D and the width W at arbitrarily-selected five positions, and obtaining an average value thereof.

In a case where a plurality of the light emitting elements 15 are installed, the sizes of the light emitting elements 15 such as the depths D of the light emitting elements 15 or the widths W of the light emitting elements 15 may be different among the light emitting elements 15 and may be appropriately selected according to the materials of the core layer 11, the first cladding layer 121, the second cladding layer 122, and the light reflecting layer 13, and the purpose of the laminate 10 or 20.

In a case where a plurality of the light emitting elements 15 are installed, the interval L between the light emitting element 15 and the adjacent light emitting element 15 may be different among the light emitting elements and can be appropriately selected according to the materials of the core layer 11, the first cladding layer 121, the second cladding layer 122, and the light reflecting layer 13 and the purpose of the laminate 10 or 20.

The interval L between the light emitting element 15 and the adjacent light emitting element 15 is preferably in a range of 1 to 10000 μm, more preferably in a range of 5 to 5000 μm.

In addition, the interval L between the light emitting element 15 and the adjacent light emitting element 15 is defined as the shortest distance between the deepest portion of the light emitting element 15 and the deepest portion of the adjacent light emitting element 15.

The interval L between the light emitting element 15 and the adjacent light emitting element 15 can be calculated by photographing the laminate 10 or 20 where the light emitting elements 15 are installed with a microscope, measuring the interval L at arbitrarily-selected five positions, and obtaining an average value thereof.

Since yellowing of the laminate can be prevented, the radius of curvature of the distal end portion of the light emitting element 15 is preferably 10 μm or less, more preferably in a range of 0.001 to 10 μm, still more preferably in a range of 0.01 to 3 μm, even still more preferably in a range of 0.05 to 0.20 μm. The radius of curvature of the distal end portion of the light emitting element 15 is measured as follows.

The laminate is mounted on a horizontal plane, and the laminate is cut in a vertical direction so as to include the deepest portion of the light emitting element 15.

In a case where the light emitting element 15 is a line-shaped concave portion, the cut surface is perpendicular to a straight line or a curve existing in the deepest portion of the light emitting element 15.

After that, mirror surface machining is performed on the cut surface by using a mirror surface machine, and an observation test sample is produced. The obtained observation test sample is set on an inspection microscope (for example, “ECLIPS L200N” produced by Nikon Co., Ltd.), and a radius of curvature of the distal end portion of the light emitting element 15 is measured by using a radius-of-curvature measurement function in setting of transmission observation with X50 observation lens.

With respect to the light emitting element 15, the light reflecting layer 13 or the design layer or light diffusion layer 14 may be installed after the installation of the light emitting element 15, or the light emitting element 15 may be installed after the installation of the light reflecting layer 13 or the design layer or light diffusion layer 14. Among the procedures of installing the light emitting element 15, since a large depth of the light emitting element 15 penetrating the light reflecting layer 13 or the design layer or light diffusion layer 14 is not needed and stable processing can be performed, the procedure of installing the light reflecting layer 13 or the design layer or light diffusion layer 14 after the installation of the light emitting element 15 is preferred.

The light emitting element 15 is installed in the laminate 10 or 20 by press processing. If the light emitting elements 15 are installed by press processing, since all the light emitting elements 15 can be installed at one-time process, the process can be simplified, so that yellowing of the laminate 10 or 20 as in laser processing can be prevented.

The condition of the press processing may be appropriately set by considering the material or the like of the laminate 10 or 20.

As described above, the shape, size, depth, interval, and the like of the light emitting element 15 installed by the press processing may be appropriately set according to the amount of light, optical guiding distance, an emission type required in the laminate 10 or 20, or the like.

As a machining blade used for the press processing, for example, a corrosion type (pinnacle type), a Thomson type, an engraved type, and the like can be exemplified. One type of these machining blades used for the press processing may be solely used, and two or more types may be used in combination. Among these machining blades used for the press processing, since a fine shape of blade can be installed, the corrosion type is preferred.

Since yellowing of the laminate 10 or 20 can be prevented, the temperature during the press processing period is preferably in a range of 5 to 50° C., more preferably in a range of 10 to 40° C. Since the light emitting element 15 can be efficiently installed by the press processing, the applied pressure during the press processing period is preferably in a range of 10 kN to 2000 kN, more preferably in a range of 20 kN to 1000 kN.

As an apparatus used for the press processing, for example, a mechanical press, a hydraulic press, and the like can be exemplified.

The obtained laminate 10 or 20 may be cut in a desired size according to the purpose by using a well-known method.

The yellowness index YI of the laminate according to the invention is preferably −3 or less, more preferably in a range of −15 to −3, still more preferably in a range of −10 to −4.

The yellowness index denotes a value of transmittance measured in accordance with ASTM Standard D1925.

(Light Guide Body for Light Source Device 10 or 20)

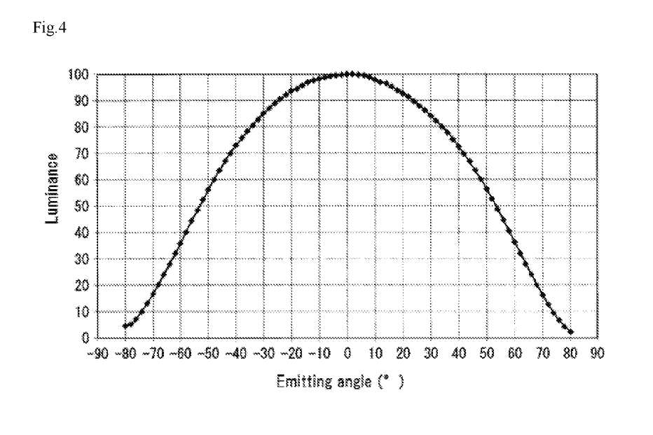

The laminate according to the invention can be used as a light guide body for light source device. In FIG. 3, the laminate 10 or 20 according to the invention is used as a light guide body for light source device 10 or 20.

(Light Source Device 30)

A light source device can be obtained by using the laminate according to the invention as the light guide body for light source device.

FIG. 2 is a schematic cross-sectional diagram illustrating an embodiment of a light source device 30 using the laminate 10 or 20 according to the invention as the light guide body for light source device 10 or 20. The light source device 30 illustrated in FIG. 3 uses the laminate 10 or 20 according to the invention as the light guide body for light source device 10 or 20 and includes a light source 31 at the light incidence surface side and a design layer or light diffusion layer 14 at the light emitting surface side.

As the light source 31, for example, for example, a light source where a plurality of well-known point light sources such as LEDs are arranged, a well-known line-shaped light source, and the like can be exemplified. In the case of using the light source where a plurality of the point light sources such as LEDs are arranged, preferably, the light sources are arranged so that the direction of the maximum intensity of light is adjusted.

The light source device 30 may include the design layer or light diffusion layer 14 on the light emitting surface.

The design layer or light diffusion layer 14 may be separated from the light guide body for light source device 10 or 20 and may be in contact with the light guide body for light source device through an adhesive layer or the like. Due to the capability of thinning the light source device 30 and the suppression of production cost, preferably, the design layer or light diffusion layer is in contact with the light guide body for light source device through an adhesive layer or the like.

As the adhesive layer, the adhesive layers described above can be used.

Due to little yellowing, the light source device 30 can be appropriately used, for example, as a light source device of a liquid crystal display device used for a mobile phone, a notebook PC, an LCD TV, a video camera, or the like, a light source device of a display device such as backlight keys of a mobile phone, a backlight keyboard of a PC, or a display switch of an electronic apparatus or a car, or a light source device of an illumination device or the like of indoor lighting such as a ceiling light or an illumination signboard.

### EXAMPLE

Hereinafter, the invention will be described specifically with reference to examples, but the invention is not limited to the examples.

### Measurement of Luminance Distribution

Each of LEDs arranged as the light sources 31 was allowed to emit light at 67 mA, and by using a luminance meter (model name: “BM-7A” produced by Topcon Technohouse Corporation), when the light guide body for light source device was mounted on a horizontal plane in parallel to the light guiding direction of the light emitting from the light emitting surface having an area of 8 millimeter square of which center was the central position of the light guide body for light source device, a luminance distribution at an emitting angle of −80° to 80° of a plane parallel to the vertical direction was measured at a distance of 500 mm from the light emitting surface.

In addition, with respect to the light emission direction, when the light guide body for light source device was mounted on the horizontal plane, the vertical upward direction was set to 0°, one light incidence surface side was set to the − (minus) side, and the opposite light incidence surface side was set to the + (plus) side. In addition, in FIG. 4, the luminance was a relative value as the maximum value was set to 100.

### Example 1

A laminate having a thickness of the first cladding layer 121 of 20 μm, a thickness of the second cladding layer 122 of 20 μm, and a total thickness of the laminate of 0.7 mm was obtained through multilayer melt extrusion by using a polycarbonate resin (product name: “TARFLON LC2200”, produced by Idemitsu Kosan Co., Ltd., refractive index n₁=1.585) as the material of the core layer 11 and using an acrylic resin (product name: “ACRYPET VH000”, produced by Mitsubishi Rayon Co., Ltd., refractive index n₂=1.49) as the material of the first cladding layer 121 and the second cladding layer 122.

By installing the light reflecting layer 13 on the first surface of the first cladding layer 121 of the obtained laminate and installing the light emitting element 15 on the second surface of the second cladding layer 122 of the obtained laminate, the laminate 10 was obtained. The light reflecting layer 13 was installed through a screen printing method using white ink. The thickness of the light reflecting layer 13 was 2 μm. The light emitting element 15 was a concave portion having a straight line shape penetrating the first cladding layer 121 and reaching an inner portion of the core layer 11. The interval between the concave portion and the adjacent concave portion was 600 μm, the depth of the concave portion was 92 μm, and the radius of curvature of the distal end portion of the concave portion was 0.22 μm. The light emitting element 15 was installed through the process processing with an applied pressure of 45 kN by using a press processing machine (model name: “TP-45EX” produced by Amada Co., Ltd.) equipped with a mold where a corrosion type machining blade was installed.

The obtained laminate 10 was used as the light guide body for light source device 10 without any modification. Two facing side surfaces of the light guide body for light source device 10 were set to the light incidence surfaces. By arranging one LED (white chip LED, product name: “NSSW157T”, produced by Nichia Corporation) as the light source 31 in each of the light incidence surfaces 16 so as to face the respective light incidence surfaces, the light source device 30 was obtained. The luminance distribution of the obtained light source device 30 is illustrated in FIG. 4.

### Example 2

Except that the interval between the concave portion penetrating the first cladding layer 121 and reaching an inner portion of the core layer 11 and the adjacent concave portion was changed to 1700 μm, the same processes as those of Example 1 were performed, so that a light source device 30 in which radius of curvature of the distal end portion of the concave portion as the light emitting element 15 of the laminate 10 was 0.18 μm was obtained.

### Example 3

Except that the interval between the concave portion penetrating the first cladding layer 121 and reaching an inner portion of the core layer 11 and the adjacent concave portion was changed to 3500 μm, the same processes as those of Example 1 were performed, so that a light source device 30 in which the radius of curvature of the distal end portion of the concave portion as the light emitting element 15 of the laminate 10 was 0.15 μm was obtained.

### Comparative Example 1

Except that the light emitting element 15 was installed by laser processing using a CO₂ laser processing machine (model name “PLS4.75” produced by Universal Laser Systems, Inc.) and the shape and interval of the light emitting element 15 were changed, the same processes as those of Example 1 were performed.

The light emitting element 15 was a concave portion having a conical shape penetrating the first cladding layer 121 and reaching an inner portion of the core layer 11. The interval between the concave portion and the adjacent concave portion was 600 μm, the depth of the concave portion was 117 μm, and the radius of curvature of the distal end portion of the concave portion was 32 μm.

With respect to the laminates 10 required in Examples 1 to 3 and Comparative Example 1, values of the interval between the concave portion and the adjacent concave portion, the depth of the concave portion, the radius of curvature of the distal end portion of the concave portion, the yellowness index YI, and a change in yellowness index ΔYI are listed in Table 1.

In addition, the yellowness index YI was measured in accordance with ASTM Standard D1925. The change in yellowness index ΔYI is a value obtained by subtracting YI of the laminate before installation of the concave portion from YI of the laminate after installation of the concave portion.

TABLE 1

| | Interval of | Depth of | Radius of Curva- | | |
|---|---|---|---|---|---|
| | Concave | Concave | ture of Distal | | |
| | Portion | Portion | End Portion of | | |
| | (μm) | (μm) | Concave (μm) | YI | ΔYI |
| Example 1 | 600 | 92 | 0.22 | −4.21 | −0.18 |
| Example 2 | 1700 | 92 | 0.18 | −4.31 | −0.28 |
| Example 3 | 3500 | 92 | 0.15 | −4.32 | −0.29 |
| Comparative | 600 | 117 | 32 | −2.14 | 1.89 |
| Example 1 | | | | | |

### INDUSTRIAL APPLICABILITY

According to a laminate obtained by a method for producing a laminate according to the invention, it is possible to obtain a light source device having little yellowing. The obtained light source device can very appropriately used, for example, as a light source device of a liquid crystal display device used for a mobile phone, a notebook PC, an LCD TV, a video camera, or the like, a light source device of a display device such as backlight keys of a mobile phone, a backlight keyboard of a PC, or a display switch of an electronic apparatus or a car, or a light source device of an illumination device or the like of indoor lighting such as a ceiling light or an illumination signboard.

### EXPLANATIONS OF LETTERS OR NUMERALS

10, 20: laminate

11: core layer

121: first cladding layer

122: second cladding layer

13: light reflecting layer

14: design layer or light diffusion layer

15: light emitting element

10, 20: light guide body for light source device

30: light source device

31: light source

1. A laminate comprising:
a core layer;
a first cladding layer;
a second cladding layer; and
a light emitting element,
wherein the second cladding layer, the core layer, and the first cladding layer are sequentially laminated,
wherein a refractive index of the first cladding layer and a refractive index of the second cladding layer are lower than a refractive index of the core layer,
wherein the light emitting element is a concave portion penetrating the first cladding layer and reaching an inner portion of the core layer, and
wherein a radius of curvature of a distal end portion of the concave portion is 10 μm or less.

2. The laminate according to claim 1, wherein the radius of curvature of the distal end portion of the concave portion is 3 μm or less.

3. The laminate according to claim 1, wherein the light emitting element is installed by press processing.

4. The laminate according to claim 1, wherein a depth of the light emitting element is larger by 5 μm or more than a thickness of the first cladding layer.

5. A laminate comprising:
a core layer;
a first cladding layer;
a second cladding layer; and
a light emitting element,
wherein the second cladding layer, the core layer, and the first cladding layer are sequentially laminated,
wherein a material constituting the core layer is a polycarbonate resin,
wherein a refractive index of the first cladding layer and a refractive index of the second cladding layer are lower than a refractive index of the core layer,
wherein the light emitting element is a concave portion penetrating the first cladding layer and reaching an inner portion of the core layer, and
wherein a yellowness index of the laminate measured in accordance with ASTM Standard D1925 is −3 or less.

6. The laminate according to claim 5, wherein a radius of curvature of a distal end portion of the concave portion is 10 μm or less.

7. The laminate according to claim 1, further comprising a light reflecting layer.

8. The laminate according to claim 1, further comprising a layer of at least one type selected from a group including a design layer and a light diffusion layer.

9. A method for producing a laminate comprising:
laminating a first cladding layer on a first surface of a core layer;
laminating a second cladding layer on a second surface of the core layer; and
installing a light emitting element,
wherein a refractive index of the first cladding layer and a refractive index of the second cladding layer are lower than a refractive index of the core layer, and
wherein the light emitting element is installed by press processing.

10. The method for producing a laminate according to claim 9, wherein the light emitting element is a concave portion penetrating the first cladding layer and reaching an inner portion of the core layer.

11. The method for producing a laminate according to claim 9, wherein a radius of curvature of a distal end portion of the concave portion is 10 μm or less.

12. The method for producing a laminate according to claim 9, wherein a machining blade used for the press processing is of a corrosion type.

13. A laminate obtained by the method for producing a laminate according to claim 9.

14. A light guide body for light source device comprising the laminate according to claim 1.

15. A light source device comprising the laminate according to claim 1.
